(19) United States
(12) Patent Application Publication
(10) Pub. No.: US 2007/0044516 A1
(43) Pub. Date: Mar. 1, 2007

(54) Method of treating the inner surface of silica tube, manufacturing method of optical fiber preform, and manufacturing method of optical fiber

(75) Inventors: Toshiki Taru, Bath (GB); Takashi Sasaki, Yokohama-shi (JP); Masaaki Hirano, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/512,347

(22) Filed: Aug. 30, 2006

(30) Foreign Application Priority Data
Sep. 1, 2005 (JP) 2005-253887

(51) Int. Cl. C03B 37/028; C03B 37/01

(52) U.S. Cl. 65/412; 65/426

(57) ABSTRACT

Provided are a method of treating the inner surface of a silica tube, an optical fiber preform manufacturing method, and an optical fiber manufacturing method, in which the amount of discharge of a global warming gas is less than that in the case of a conventional method. The method of treating the inner surface of a silica tube comprises a step of heating the silica tube so as to have a temperature of 1800° C. or more while supplying a gas containing chlorine into the inside of the silica tube, thereby treating the inner surface of the silica tube with chlorine. The optical fiber preform manufacturing method further comprises a step of processing the silica tube into a rod. The optical fiber manufacturing method comprises a step of drawing an optical fiber preform prepared by the optical fiber preform manufacturing method.

### BACKGROUND OF THE INVENTION

1. Field of the Invention

The present invention relates to a method of inner surface treatment of a silica tube, a manufacturing method of an optical fiber preform, and a manufacturing method of an optical fiber.

2. Description of the Background Art

A plurality of glass members are combined to produce an optical fiber preform. In order to obtain a low-loss optical fiber, it is necessary to decrease impurities in interfaces between the glass members in an optical waveguide region in the process of manufacturing an optical fiber preform. Voids and foreign substances in interfaces between glass members result in degradation of reliability of the optical fiber even if the interfaces do not exist in the optical waveguide region.

Therefore, in order to obtain a low-loss optical fiber having high reliability, the inner surface treatment of a silica tube to be used in the manufacture of an optical fiber preform is implemented. In the past, the vapor-phase etching using CF₄ gas or SF₆ gas has been adopted in the inner surface treatment of such a silica tube. (For example, see Japanese Patent Application Laid-Open No. S56-73637 or Japanese Patent Application Laid-Open No. S55-90430.)

However, in this vapor-phase etching, the CF₄ gas and SF₆ gas are not completely consumed, and some of them are discharged as unreacting gas. Such CF₄ gas and SF₆ gas are gases designated as global warming gases, and therefore it is desired to reduce the amount of their use.

### SUMMARY OF THE INVENTION

An object of the present invention is to provide a method of treating the inner surface of a silica tube, an optical fiber preform manufacturing method, and an optical fiber manufacturing method, in which the amount of discharge of a global warming gas is less than that in the case of conventional methods.

In order to achieve such object, a method of treating the inner surface of a silica tube includes a step of heating the silica tube so as to have a temperature of 1800° C. or more while supplying a gas containing chlorine into the inside of the silica tube, thereby treating the inner surface of the silica tube with chlorine.

In the step of the inner surface treatment of a silica tube, it is preferable to heat the silica tube using a resistance furnace or an induction furnace as a heat source therefor and to heat the silica tube in a state where the inside of the silica tube is controlled so as to have a positive pressure. Also, preferably the inner surface treatment is implemented after performing a pre-treatment in which the silica tube is heated at a temperature lower than 1800° C. while the gas containing chlorine is supplied into the inside of the silica tube.

Another aspect of the invention provided in order to achieve the object is a method of manufacturing an optical fiber preform, which comprises a step of treating the inner surface of a silica tube by heating the silica tube so as to have a temperature of 1800° C. or more while supplying a gas containing chlorine into the inside of the silica tube and a step of processing the silica tube into a rod. Yet another aspect of the invention is an optical fiber manufacturing method in which an optical fiber is manufactured by drawing an optical fiber preform prepared by the optical fiber preform manufacturing method of the present invention.

### BRIEF DESCRIPTION OF THE DRAWINGS

These aspects, features, and advantages of the present invention will be better understood through the following description, appended claims, and accompanying drawings. In the explanation of the drawings, an identical mark designates identical elements and an overlapping explanation will be omitted.

FIG. 1 is a flow chart showing a first embodiment of the manufacturing method of an optical fiber according to the present invention.

FIG. 2 is a schematic diagram showing the inner surface treatment process of the first embodiment.

FIG. 3 is a schematic diagram showing a fiber drawing process.

FIG. 4 is a graph showing the calculation results of temperature dependence of the quantity of vapor-phase compound formed from SiO₂ under a chlorine gas atmosphere.

FIG. 5 is a flow chart showing a second embodiment of the optical fiber manufacturing method according to the present invention.

FIG. 6 is a schematic diagram showing the inner surface treatment process of the second embodiment.

FIG. 7 is a flow chart showing an example of modification with respect to the first embodiment of the manufacturing method of the optical fiber according to the present invention.

### DETAILED DESCRIPTION OF THE INVENTION

The present inventors, aiming at chlorine capable of removing impurities and moisture which exist on a glass surface, have found that a part of the glass surface can be removed by causing the glass to have a high temperature of 1800° C. or more under a chlorine atmosphere, and have completed the present invention.

### First Embodiment

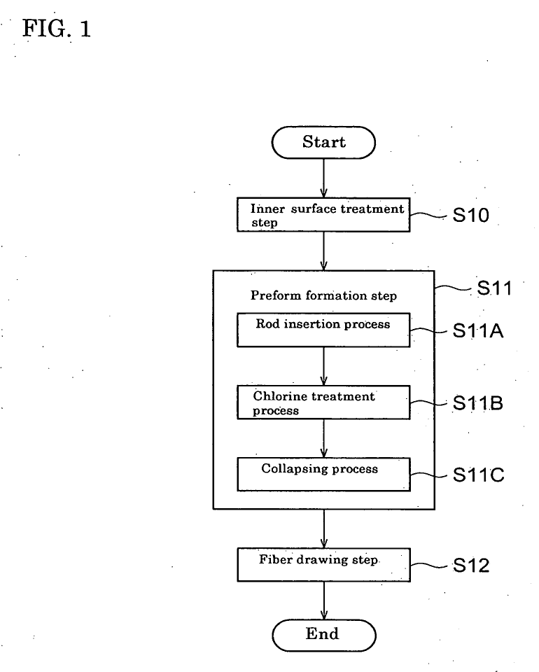

FIG. 1 is a flow chart showing a first embodiment of the manufacturing method for an optical fiber according to the present invention. The first embodiment, which is a method of manufacturing an optical fiber by drawing an optical fiber preform prepared by the rod-in-tube method, comprises an inner surface treatment step S10, a preform formation step (process of forming a silica tube into a rod) S11, and a fiber drawing step S12.

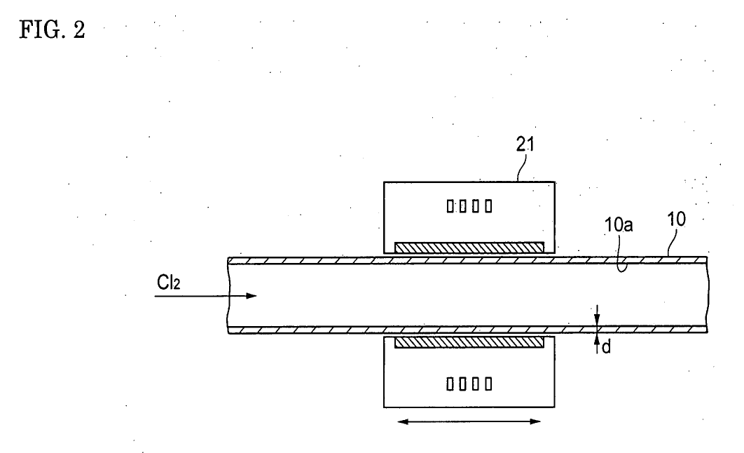

FIG. 2 is a schematic diagram showing the inner surface treatment step of the first embodiment. In the inner surface treatment step S10, the inner surface of a silica tube to be used in the rod-in-tube method is cleaned. First, a silica tube 10 which is to be processed into a cladding region is set on the lathe (not shown in the figure). In this case, handling tubes (not illustrated in the figure) are connected to both ends of the silica tube 10, and the silica tube 10 is set on the lathe through the handling tubes in a manner such that it can rotate about the central axis thereof. The material of the silica tube 10 is, for example, a pure silica glass, a fluorine-doped silica glass, or a chlorine-doped silica glass, etc. From the viewpoint of restraining the deformation of the silica tube 10 which is caused by heating the silica tube 10 at high temperature, preferably, the silica tube 10 has a wall thickness of 15 mm or more.

After the silica tube 10 is set on the lathe, a chlorine gas is flowed from one end of the silica tube 10 toward the other end while the silica tube 10 is heated, using an induction furnace 21 as the heat source, so that the silica tube 10 may have a temperature of 1800° C. or more. Here, the temperature of the silica tube 10 means the temperature on the outer surface of the silica tube 10. In such process, while the silica tube 10 is caused to rotate about the central axis thereof, the induction furnace 21 is moved in the longitudinal direction (a direction parallel to the flowing direction of the chlorine gas) of the silica tube 10.

In the inner surface treatment step S10, the inner surface treatment of the silica tube 10 is performed by heating the silica tube 10 to a temperature of 1800° C. or higher while flowing the chlorine gas. More specifically, a part of the inner surface 10a is evaporated and removed. Also, as a result of processing at a high temperature of 1800° C. or higher, the glass surface is smoothed due to the viscous flow thereof, resulting in formation of a surface which is capable of restraining the generation of voids in a subsequent process. In view of facilitating such smoothing process, it is preferable that the silica tube 10 be doped with at least either one of fluorine and chlorine. The viscosity of glass decreases as a result of fluorine or chlorine being added. Thus, the temperature needed for smoothing the silica tube 10 can be lowered and the smoothing effect can easily occur.

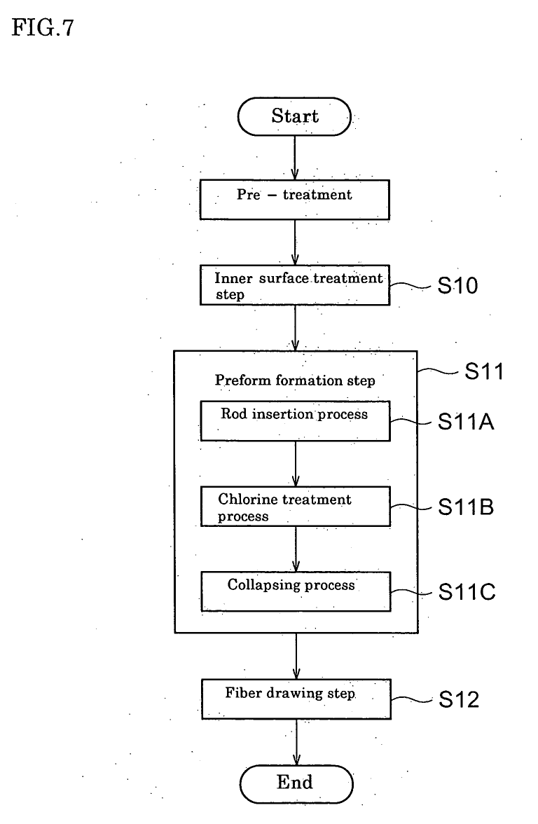

It is preferable that prior to the step of heating the silica tube 10 so as to have a temperature of 1800° C. or more, the silica tube 10 be heated at a temperature (a temperature lower than 1800° C.), while a chlorine gas is flowed into the inside of the silica tube 10, (pre-treatment) (See FIG. 7), at which temperature neither the removal of the inner surface of the silica tube nor the smoothing of the surface occurs. When such heating is done at a temperature which is lower than 1800° C. (e.g., 500° C.), neither the evaporation of the inner surface 10a nor the viscous flow occurs; however, a part of the impurities on the inner surface 10a are removed by the chlorine gas. Thus, even if the viscous flow occurs in a subsequent process because of the heat treatment performed at a high temperature equal to or more than 1800° C., impurities are hardly taken into the inner surface 10a of the silica tube 10 since a part of the impurities on the inner surface 10a are removed beforehand. Consequently, the amount of the impurities contained in the optical fiber manufactured using the silica tube 10 is more decreased, and accordingly the reduction of transmission loss and the improvement of the reliability can be achieved.

In a preform formation step S11 (process of transforming a silica tube into a rod), which is a step subsequent to the inner surface treatment step S10, an optical fiber preform is produced using the silica tube 10 which has been subjected to the inner surface treatment. The optical fiber preform formation step S11 comprises a rod insertion process S11A, a chlorine treatment process S11B, and collapsing process S11C.

First, in the rod insertion process S11A, a silica glass rod having an outer diameter smaller than the caliber of the silica tube 10 is inserted into the silica tube 10 which has been subjected to the inner surface treatment. The silica glass rod, which is to become a core region, is doped with chlorine.

Subsequently, in the chlorine treatment process S11B, a chlorine gas is flowed into the clearance between the silica glass rod and the silica tube 10, and a heat treatment is done at a temperature lower than 1800° C., which is the temperature for the inner surface treatment step S10. Thus, impurities on the surface of the silica glass rod which is to become a core region are removed. Subsequently, in the collapsing process S11C, after one end of the silica tube 10 in which a silica glass rod is inserted is completely sealed by fusing, the silica tube 10 and the silica glass rod are united (collapsing) by heating in an oxygen atmosphere under decompressed conditions, and thereby an optical fiber preform 11 is formed.

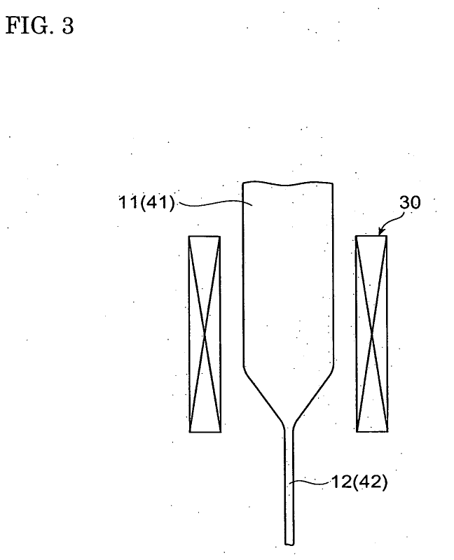

FIG. 3 is a schematic diagram showing a fiber drawing process. Subsequently, in the fiber drawing step S12, the optical fiber preform 11 manufactured in the preform formation step S11 is set in a drawing furnace 30 and subjected to fiber drawing, and thereby an optical fiber 12 is produced.

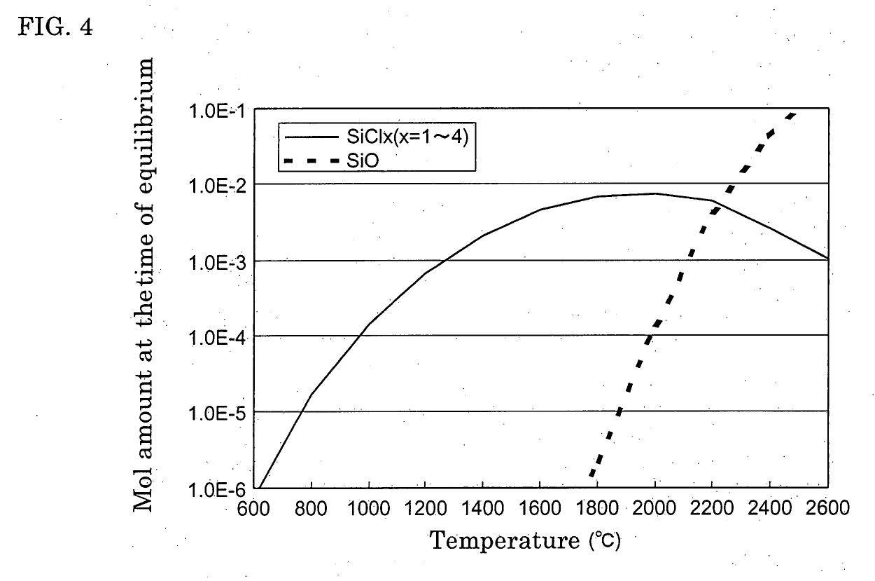

In the optical fiber manufacturing method of the first embodiment, it is important to clean the inner surface 10a by heating while supplying a chlorine gas into the inside of the silica tube 10 such that the silica tube 10 has a high temperature of 1800° C. FIG. 4 is a graph showing the calculation results of temperature dependence of the quantity of vapor-phase compound formed from SiO₂ under a chlorine gas atmosphere. More specifically, it shows the results of calculation of the amount of Si compound, which are obtained by implementing chemical equilibrium calculation at the time of equilibrium in the case where 1 mol of SiO₂ and 1 mol of Cl₂ coexist under 1 atm.

As shown in FIG. 4, at a temperature of 1800° C. or more, the vapor-phase Si compound (SiClₓ (x is 1, 2, 3, 4) and SiO) is formed in a large amount. SiClₓ is generated by the reaction to chlorine and the generated amount is the largest at a temperature in the range of 1800° C.-2000° C. SiO, which is generated by the sublimation reaction, is temperature dependent and becomes dominant as a vapor-phase product at a temperature of 2200° C. or more. It remains in the optical fiber preform after collapsing the silica tube.

By heating under the chlorine atmosphere so that the silica tube 10 may have a temperature of 1800° C. or higher, a part of the inner surface 10a is evaporated by chlorine gas and is removed. This results in cleaning of the inner surface 10a of the silica tube 10 under the conditions where SF₆ gas and CF₄ gas are not used at all or the use thereof is reduced, and makes it possible to more securely remove the impurities and moisture or the like existing on the inner surface 10a. Thus, an optical fiber preform in which impurities or the like is decreased can be manufactured. Also, in the optical fiber 12 manufactured using the silica tube 10 which has been subjected to the inner surface treatment, the transmission loss due to the impurities and moisture or the like is reduced, resulting in superior reliability thereof.

In the past, when an optical fiber preform is manufactured, a SF₆ gas or CF₄ gas which are considered to be a source of global warming have been discharged, since the inner surface treatment of a silica tube was performed by means of the vapor-phase etching using a SF₆ gas or a CF₄ gas. In contrast, no global warming gas is discharged in the optical fiber manufacturing method of the first embodiment because the inner surface treatment of a silica tube is implemented with chlorine gas without using a SF₆ gas or a CF₄ gas at all, and accordingly the inner surface treatment is a method which is gentle to the environment of the earth.

In the past, it has generally been thought that a silica tube would be deformed if it is heated at a high temperature of 1800° C. or more. In the optical fiber manufacturing method of the first embodiment, however, the deformation of the silica tube 10 can be restrained since the silica tube 10 is heated by the radiation heat with an induction furnace 21.

### Second Embodiment

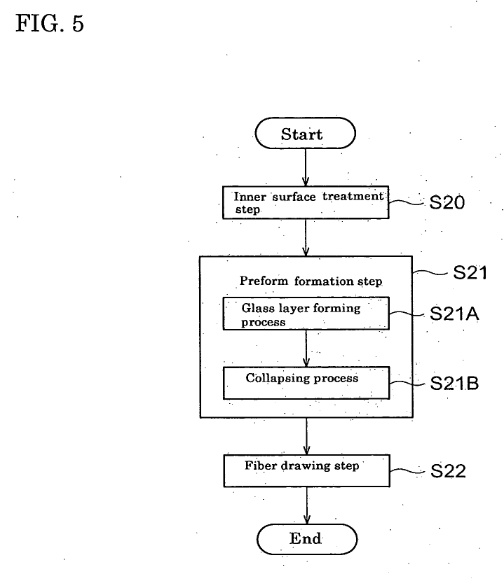

FIG. 5 is a flow chart showing a second embodiment of the optical fiber manufacturing method according to the present invention. The second embodiment of the manufacturing method, in which an optical fiber is produced by drawing an optical fiber preform prepared by using the Modified Chemical Vapor Deposition (MCVD) method, comprises an inner surface treatment step S20, a preform formation step (a process for transforming a silica tube into a rod) S21, and a fiber drawing step S22.

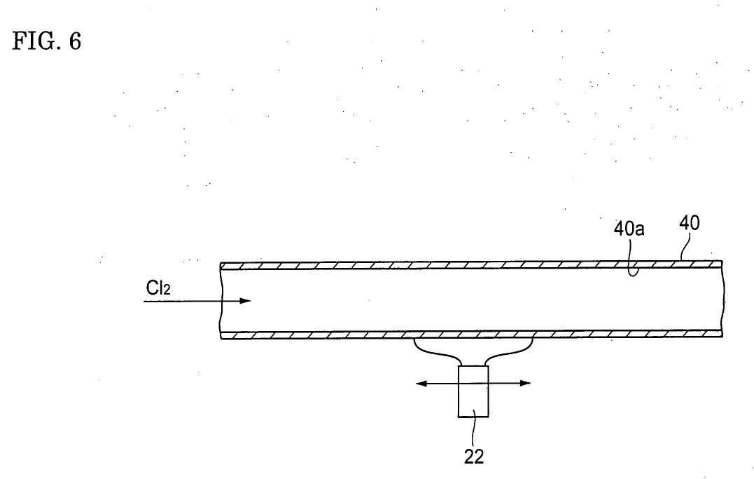

FIG. 6 is a schematic diagram showing the inner surface treatment step of the second embodiment. In the inner surface treatment step S20, first, a silica tube 40, which is formed of pure silica glass, for example, and which will become a part of a cladding region, is set on the MCVD lathe (not illustrated in the figure). Thereafter, while heating the outer periphery of the silica tube 40 with an oxyhydrogen burner 22 as a heat source so that the temperature of the silica tube 40 may become 1800° C. or higher, a chlorine gas is flowed into the inside of the silica tube 40. In this case, the silica tube 40 is caused to rotate about the central axis thereof at a pre-determined turning speed, and the oxyhydrogen burner 22 is moved at a predetermined speed in the longitudinal direction of the silica tube 40. Moreover, in order to prevent the silica tube 40 from being deformed, the internal pressure of the silica tube 40 is controlled using an internal pressure control mechanism which is usually provided in MCVD lathe so that the internal pressure of the silica tube 40 may become a positive pressure higher than the outside pressure. It is particularly effective to make the inside pressure of the silica tube 40 to be a positive pressure in the case where the wall thickness of the silica tube 40 is as thin as 6 mm, for example.

Next, in the preform formation step S21, an optical fiber preform is formed using the silica tube 40 in which the inner surface 40a has been treated. The preform formation step S21 includes a glass layer forming process S21A and a collapsing process S21B. In the glass layer forming process S21A, a glass layer which is to become a cladding region and a Ge-doped glass layer which is to become a core region are deposited in order on the inner surface of the silica tube 40 which inner surface has been treated. Then, in the subsequent collapsing process S21B, the collapsing is performed and the rod thus prepared by the collapsing is provided with an overcladding, and thereby an optical fiber preform 41 is obtained. In the fiber drawing process S22, the optical fiber preform 41 prepared in the preform formation step S21 is drawn into an optical fiber 42 in a drawing furnace 30 as shown in FIG. 3.

In the second embodiment also, the inner surface treatment of the silica tube can be accomplished without discharging any global warming gas since the inner surface treatment of the silica tube 40 is implemented using a chlorine gas without using the SF₆ gas and CF₄ gas which are global warming gases, and therefore the optical fiber manufacturing method is suitable for the earth environment. Also, since the chlorine gas is supplied to the silica tube 40 while the silica tube 40 is heated at a temperature of 1800° C. or higher, a part of the inner surface of the silica tube 40 can be evaporated and removed. Thus, it is possible to manufacture an optical fiber preform in which the contents of impurities and the like are decreased. Also, the optical fiber 42 can be produced without being contaminated with impurities, moisture, or the like in the cladding region, and consequently the transmission loss of the optical fiber 42 thus obtained is reduced, resulting in high reliability.

The embodiments of the present invention are not limited to the above-described preferred embodiments. For example, as for the heat source, an induction furnace 21 is used in the first embodiment, and an oxyhydrogen burner 22 is used in the second embodiment; however, a resistance furnace may be used instead of the induction furnace 21 and the oxyhydrogen burner 22 if the silica tubes 10 and 40 can be heated such that the temperature of the silica tubes 10 and 40 become equal to or more than 1800° C. The resistance furnace and the induction furnace which heat the silica tubes 10 and 40 by means of radiation heating are preferable from the viewpoint that even if the silica tubes 10 and 40 are heated at a temperature of 1800° C. or higher, the silica tubes 10 and 40 are not easily deformed and the blowing-off of the surface layer can be restrained.

Moreover, in the inner surface treatment steps S10 and S20, the gas to be introduced into the silica tubes 10 and 40 is a chlorine gas in which the SF₆ gas and CF₄ gas are not included; however, other kind of chlorine-containing gas may be used. In the case where the impurities containing carbon are adhered on the inner surfaces 10a and 40a of the silica tubes 10 and 40, it is preferable to include oxygen in the gas to be introduced into the silica tubes 10 and 40, since the impurities can be removed by a vapor-phase oxidation thereof The treatment using oxygen may be performed prior to the heat treatment conducted at a temperature equal to or more than 1800° C. in the inner surface treatment process with a gas containing chlorine. Also, a SF₆ gas or a CF₄ gas may be contained in the gas to be introduced into the silica tubes 10 and 40 if the contained amount is so small as not to generate an un-reacted gas, being consumed through the reaction with the silica tubes 10 and 40.

For preparing the silica tubes 10 and 40, a through-hole is formed in a solid silica glass by machining and the tubular glass body thus formed is elongated. Therefore, it is preferable to perform the inner surface treatment processes S10 and S20 at the same time when the silica tubes 10 and 40 are elongated. The temperature for heating the silica tubes 10 and 40 is equal to or more than 1800° C. when the silica tubes 10 and 40 are to be elongated, and therefore the vapor-phase removal is possible, which can be performed simultaneously with the expansion process, allowing the improvement of the productivity.

### EXAMPLE 1

An optical fiber was manufactured according to the method of the first embodiment. First, a hole was formed by machining in a rod composed of silica glass in which fluorine was doped so that the relative refractive index difference to the un-doped silica was −0.33%, and thereby a silica tube 10 having an outer diameter of 75 mmφ and an inner diameter of 8 mmφ was formed. Subsequently, after treating the inner and outer superficies of the silica tube 10 with an HF solution for a predetermined time in order to remove the solution generated as a result of the machining process, a handling tube was connected to each end thereof, and it was set on a lathe. Then, while heating by the induction furnace 21 is conducted so that the temperature of the silica tube 10 becomes equal to or more than 1800° C., a chlorine gas was flowed at 1000 sccm into the silica tube 10. During that time, the traverse movement of the induction furnace 21 was repeated five times at a speed (traverse velocity) of 25 mm/minute from the upstream side toward the downstream side of the flowing direction of the chlorine gas. Also, the number of rotations of the silica tube 10 caused by the lathe was 30 rotations per min.

Next, in the rod insertion process S11A, a chlorine-doped silica glass rod having an outer diameter of 5 mmφ was inserted into the silica tube 10. This silica glass rod was formed from a soot body synthesized by a vapor-phase axial deposition (VAD) method, by dehydrating and consolidating the soot body in an atmosphere including SiCl₄, and elongating the consolidated body by heating in an anhydrous atmosphere with a resistance furnace. The silica glass rod had a relative refractive index difference of 0.06%. Subsequently, an optical fiber preform 11 was produced by performing a chlorine treatment process S11B and a collapsing process S11C. Next, the fiber drawing step S12 was implemented. Thus, an optical fiber 12 was prepared and the transmission loss thereof was evaluated.

Then, the transmission loss was compared with that of an optical fiber made under the same conditions except that the inner surface treatment of the silica tube 10 was conducted by an conventional etching method using a SF₆ gas. As a result, it was found that in the optical fibers 12 the transmission losses due to metallic impurities at the 1.55 μm wavelength band were substantially equal to each other. Also, the difference between the optical fibers in terms of the transmission loss due to OH absorption at the 1.38 μm wavelength band was 0.2 dB/km, and thus, both of the optical fibers had substantially equal losses.

### EXAMPLE 2

An optical fiber was manufactured according to the second embodiment. First, a silica tube 40 having an outer diameter of 25 mmφ and a wall thickness of 6 mm was set as a starting pipe on MCVD lathe. Next, a chlorine gas was flowed into the silica tube 40 at 500 sccm while the silica tube 40 was heated from the outer periphery thereof with an oxyhydrogen burner 22 so as to have a temperature of 1800° C. In this case, the inside of the silica tube 40 was controlled to a positive pressure using an internal pressure control mechanism provided in the MCVD lathe so that the silica tube 40 might be prevented from being deformed. Also, the traverse of the oxyhydrogen burner 22 was repeated four times at a velocity of 50 mm/minute from the upstream side toward the downstream side in the direction of the chlorine gas flow. And, the silica tube 10 was rotated by the lathe at a rate of 30 rotations per min.

After the inner surface treatment was completed, a rod prepared by implementing a glass layer formation process S21A and a collapsing process S21B was subjected to overcladding so as to form an optical fiber preform 41. Then, the optical fiber preform 41 thus prepared was drawn in a drawing furnace 30 in the fiber drawing step S22. Thus, the optical fiber 42 was produced and the transmission loss thereof was evaluated.

Then, the transmission loss was compared with that of an optical fiber which was produced under the same conditions except that the inner surface treatment of the silica tube 40 was conducted by the conventional etching method using SF₆. As a result, it was found that both of the optical fibers 42 had substantially equal transmission losses due to metallic impurities in the 1.55 μm wavelength band. Also, the difference between the optical fibers 42 in terms of the transmission losses due to the OH absorption in the 1.38 μm wavelength band was 0.3 dB/km, which was substantially equal for both fibers.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2005-253887 filed on Sep. 1, 2005 including the specification, claims, drawings and summary are incorporated herein by reference in its entirety.

What is claimed is:

1. A method of treating the inner surface of a silica tube, comprising a step of heating the silica tube so as to have a temperature of 1800° C. or higher while supplying a gas containing chlorine into the inside of the silica tube, thereby treating the inner surface of the silica tube with chlorine.

2. A method of treating the inner surface of a silica tube according to claim 1, wherein the silica tube is heated with a resistance furnace or an induction furnace as a heat source.

3. A method of treating the inner surface of a silica tube according to claim 1, wherein the silica tube is heated in a state where the inside of the silica tube is controlled so as to have a positive pressure.

4. A method of treating the inner surface of a silica tube according to claim 1, wherein the inner surface treatment is implemented after performing a pre-treatment in which the silica tube is heated at a temperature lower than 1800° C. while the gas containing chlorine is supplied into the inside of the silica tube.

5. A method of manufacturing an optical fiber preform, comprising steps of:
treating the inner surface of a silica tube by heating the silica tube so as to have a temperature of 1800° C. or higher while supplying a gas containing chlorine into the inside of the silica tube; and
processing the silica tube into a rod.

6. An optical fiber manufacturing method, comprising a step of drawing an optical fiber preform prepared by the optical fiber preform manufacturing method set forth in claim 5.
